(19) United States
(12) Patent Application Publication
(10) Pub. No.: US 2018/0270927 A1
(43) Pub. Date: Sep. 20, 2018

(54) DEVICE AND METHOD FOR CONTROLLING LIGHT SOURCES OF A MOTOR VEHICLE

(71) Applicant: VALEO VISION, Bobigny Cedex (FR)

(72) Inventors: Samuel DAROUSSIN, Bobigny Cedex (FR); Irantzu JAUREGI, Bobigny Cedex (FR); Silas BAKARY, Bobigny Cedex (FR)

(73) Assignee: VALEO VISION, Bobigny Cedex (FR)

(21) Appl. No.: 15/921,905

(22) Filed: Mar. 15, 2018

(30) Foreign Application Priority Data
Mar. 15, 2017 (FR) 17 52121

(51) Int. Cl. H05B 33/08; B60Q 1/04

(52) U.S. Cl. CPC H05B 33/0848; B60Q 1/04; H05B 33/0854

(57) ABSTRACT

A system for supplying electrical power to at least one semiconductor-element-including light source of a motor vehicle. The system includes a mechanism controlling the supply of electrical power to the light source and being configured to deliver an electrical current to the light source. Magnitude of the delivered electrical current depends on a bin value of the light source and on the temperature of the environment of the source. An electronic circuit, which is independent of the light source, including a first component a measurable property of which is representative of the bin value of the source, and a second component a measurable property of which is dependent on the temperature of the environment of the light source. The controller determines the properties of the first and second components via a single electrically conductive wire connecting the controller to the electronic circuit, the wire being suitable for supplying the latter with electrical current.

The invention relates to the field of lights and in particular of motor-vehicle headlamps. The invention in particular relates to a system for supplying electrical power to the light sources of such a light, the light sources being semiconductor-element-comprising sources, it being necessary to provide information on the bin of the sources to configure the light, and to provide information on the temperature thereof to deliver a suitable supply of electrical current.

A light-emitting diode, LED, is an electronic component capable of emitting light when it is passed through by an electrical current. The light intensity emitted by an LED is in general dependent on the magnitude of the electrical current flowing therethrough. Among other values, an LED is characterized by a current threshold. This maximum forward current generally decreases with temperature. Likewise, when an LED is emitting light, a voltage drop equal to its forward voltage is observed across its terminals. In the motor-vehicle field, LED technology is increasingly used in various signaling-light solutions. LEDs are used in order to provide lighting functions such as daytime running lights, signaling lights, etc. However, LED components issued from a given production process may have different properties (emission capacity, forward voltage, etc.). In order to group components having similar properties together, the produced LEDs are sorted into groups, also called bins, each bin containing LEDs having similar properties.

It is known in the art to use a control circuit to control the supply of electrical power to a set or group of LEDs. The circuit defines the electrical current applied to a load branch that comprises the group of LEDs connected in series. In the field of lighting devices for motor vehicles, it is particularly important to be able to ensure a constant luminance in order to guarantee the safety of users of the vehicle and of other road users. In order to deliver a constant supply, known control circuits use various types of converters: DC/DC, linear, resistive, etc. to convert the DC electrical current delivered, for example by an automobile battery, into a DC load current suitable for supply to the LEDs in question. The electrical current to be delivered depends on the bin of the LEDs to be supplied with power. For this reason it is, in known assembly processes, necessary to obtain the bin information that corresponds to the LEDs used, in order to correctly adjust or program the control circuit used to supply the LEDs with electrical current.

Likewise, the forward current of an LED depends on the temperature of its semiconductor junction. In the prior art, bin information has been coded using a resistor of preset resistance, this resistor being placed on the printed circuit board that bears the LEDs in question, in isolation from the load branch that contains the light sources. An indication of the temperature of the LEDs may be obtained, according to the prior art, by placing a thermistor element on a printed circuit board in physical proximity to the LEDs, the voltage drop across the terminals of said thermistor being measurable. The circuit for controlling the supply of power to these LEDs is connected by dedicated connecting wires to the printed circuit board bearing the LEDs in order to obtain the value of the resistance in question, and to deduce therefrom the bin information and the temperature information. With the increase in the number of lighting functions implemented with LEDs, the number of connecting cables connecting the one or more power-supply-controlling circuits to the printed circuit boards bearing the LEDs in question, with the aim of relaying the required bin information, temperature information and other information, has therefore rapidly increased. This leads on the one hand to substantial costs during the production of motor-vehicle headlamps, and on the other hand to substantial design constraints, since the limited space in which all the modules of a lighting device must be housed is restricted by this cabling.

The objective of the invention is to mitigate at least one of the problems of the prior art. More precisely, the objective of the invention is to decrease the number of connections between the one or more power-supply-controlling circuits and the printed circuit boards that bear the light sources to be supplied with power, while allowing all the information and light-source properties required to configure the one or more controlling circuits to be made available.

One subject of the invention is a system for supplying electrical power to at least one semiconductor-element-comprising light source of a motor vehicle. The system comprises means for controlling the supply of electrical power to said light source, said means being configured to deliver an electrical current to said light source, the magnitude of the delivered electrical current depending on a bin value of the source and on the temperature of the environment of the source. The system also comprises an electronic circuit, which is independent of said light source, comprising a first component a measurable property of which is representative of the bin value of the source, and a second component a measurable property of which is dependent on the temperature of the environment of the light source. The system is noteworthy in that the controlling means are arranged to determine said properties of the first and second components via a single electrically conductive wire connecting the controlling means to the electronic circuit.

Preferably, the single electrically conductive wire connecting the controlling means to the electronic circuit may be suitable for supplying the latter with electrical current.

Preferably, the controlling means may comprise means for reading said properties of the first component and second component. The reading means are configured:
at a first preset temperature, at which the property of the second component is known, to measure the voltage drop across the terminals of said electronic circuit, when an electrical current of a preset magnitude is flowing therethrough;
to deduce the value of the property of the first component from the measured voltage drop and from the property of the second component; and
to record the value of the property of the first component, which value is representative of the bin value of the light source, in a first memory element.

The first preset temperature is preferably an ambient temperature, preferably located between 10° C. and 40° C.

The reading means may furthermore be configured:
to measure the voltage drop across the terminals of said electronic circuit, when an electrical current of a preset magnitude is flowing therethrough;
to deduce the value of the property of the second component from the measured voltage drop and from the value of the property of the first component, i.e. the value stored beforehand in the first memory element; and
to record the value of the property of the second component, which value is representative of the temperature of the environment of the light source at the time at which the measurement is taken, in a second memory element.

The first component and the second component may preferably be mounted in parallel in the electronic circuit.

Preferably, the first component and the second component may be mounted in series in the electronic circuit.

Preferably, a first branch comprising the first component and a second branch comprising the second component may be mounted in parallel in the electronic circuit. At least one of the branches comprises a selecting mechanism mounted in series and upstream of said first/second component, the selecting mechanism being configured to let an electrical current flowing through the electronic circuit selectively pass through said branch, depending on a property of the electrical current. The controlling means may preferably comprise means for reading said properties of the first and second components, said reading means being configured to selectively inject an electrical current having a preset property into the electronic circuit.

Each of the parallel branches may preferably comprise a selecting mechanism comprising a first diode and a second diode only letting an electrical current of a given polarity pass, respectively, the diodes of the two branches letting electrical currents of inverse polarities pass. The means for reading said properties of the first component and second component may preferably be configured:
to measure the voltage drop across the terminals of said electronic circuit, when an electrical current of a preset magnitude and of a first polarity, passed by the first diode, is flowing therethrough;
to deduce the value of the property of the first component from the measured voltage drop; and
to record the value of the property of the first component, which value is representative of the bin value of the light source, in a first memory element.

Preferably, the reading means may furthermore be configured:
to measure the voltage drop across the terminals of said electronic circuit, when an electrical current of a preset magnitude and of a second polarity, which is the inverse of the first polarity and which is passed by the second diode, is flowing therethrough;
to deduce the value of the property of the second component from the measured voltage drop; and
to record the value of the property of the second component, which value is representative of the temperature of the environment of the light source at the time at which the measurement is taken, in a second memory element.

At least one of the parallel branches may comprise a selecting mechanism that comprises a capacitor that only lets pass an electrical current of a preset frequency, the frequencies for the two branches being different. The means for reading said properties of the first component and second component may preferably be configured:
to measure the voltage drop across the terminals of said electronic circuit, when an electrical current of a preset magnitude and of a first frequency, passed by the selecting mechanism of the first branch, is flowing therethrough;
to deduce the value of the property of the first component from the measured voltage drop; and
to record the value of the property of the first component, which value is representative of the bin value of the light source, in a first memory element.

Preferably, the reading means are furthermore configured:
to measure the voltage drop across the terminals of said electronic circuit, when an electrical current of a preset magnitude and of a second frequency, passed by the selecting mechanism of the second branch, is flowing therethrough;
to deduce the value of the property of the second component from the measured voltage drop; and
to record the value of the property of the second component, which value is representative of the temperature of the environment of the light source at the time at which the measurement is taken, in a second memory element.

Preferably, only the first branch of the parallel branches, i.e. the branch comprising the first component having a property representative of the bin value of the light source, will optionally comprise said selecting mechanism.

The light sources may preferably comprise light-emitting diodes (LEDs), organic light-emitting diodes (OLEDs), or laser diodes.

Preferably, the first component may be a resistor the ohmic value of which is representative of the bin value of the light source.

Preferably, the second component may be a thermistor the ohmic value of which depends on the temperature of the component. The resistance/temperature properties of the thermistor may preferably be pre-recorded in a memory element of the controlling means.

Preferably, the thermistor may have a variable resistance that increases as its temperature increases. Alternatively, the resistance of the thermistor may decrease as its temperature increases.

Preferably, the reading means may comprise a microcontroller element and/or an analog/digital converter.

Preferably, the reading means may be connected to two or more electronic circuits each comprising components the respective properties of which are representative of distinct bin values and of distinct light-source-environment temperatures. The distinct light sources may preferably be suitable for providing distinct motor-vehicle lighting functions.

Another subject of the invention is a motor-vehicle lighting module comprising at least one semiconductor-element-comprising light source and a system for supplying electrical power to said light source. The lighting module is noteworthy in that the electrical-power-supplying system is according to the invention.

Another subject of the invention is a method for supplying electrical power to at least one semiconductor-element-comprising light source via a power-supplying system according to the invention, noteworthy in that the means for controlling the supply of electrical power comprise means for reading said properties of the first component and second component. The method is noteworthy in that it comprises the following steps:

a) at a first preset temperature, at which the property of the second component is known, measuring the voltage drop across the terminals of said electronic circuit, when an electrical current of a preset magnitude is flowing therethrough;

b) deducing the value of the property of the first component from the measured voltage drop and from the property of the second component;

c) recording the value of the property of the first component, which value is representative of the bin value of the light source, in a first memory element;

d) measuring the voltage drop across the terminals of said electronic circuit, when an electrical current of a preset magnitude is flowing therethrough;

e) deducing the value of the property of the second component from the measured voltage drop and from the property of the first component, i.e. the property recorded beforehand in the first memory element;

f) recording the value of the property of the second component, which value is representative of the temperature of the environment of the light source at the time at which the measurement is taken, in a second memory element; and

g) delivering an electrical current to the light sources, the magnitude of the delivered electrical current depending on the bin value of the source and on the temperature of the environment of the light source.

Preferably, steps d) to g) may be repeated at preset times.

Another subject of the invention is a method for supplying electrical power to at least one semiconductor-element-comprising light source via a power-supplying system according to the invention, wherein the means for controlling electrical power supply comprise means for reading said properties of the first and second components and wherein, in the electronic circuit, a first branch comprising the first component and a second branch comprising the second component are mounted in parallel. Each of the parallel branches comprises a selecting mechanism mounted in series with and upstream of said first/second component and comprising a first and a second diode, respectively, each letting only an electrical current of a given polarity pass, the diodes of the two branches letting electrical currents of inverse polarities pass. The method is noteworthy in that it comprises the following steps:

aa) measuring the voltage drop across the terminals of said electronic circuit, when an electrical current of a preset magnitude and of a first polarity, passed by the first diode, is flowing therethrough;

bb) deducing the value of the property of the first component from the measured voltage drop;

cc) recording the value of the property of the first component, which value is representative of the bin value of the light source, in a first memory element;

dd) measuring the voltage drop across the terminals of said electronic circuit, when an electrical current of a preset magnitude and of a second polarity, which is the inverse of the first polarity and passed by the second diode, is flowing therethrough;

ee) deducing the value of the property of the second component from the measured voltage drop;

ff) recording the value of the property of the second component, which value is representative of the temperature of the environment of the light source at the time at which the measurement is taken, in a second memory element; and

gg) delivering an electrical current to the light sources, the magnitude of the delivered electrical current depending on the bin value of the source and on the temperature of the environment of the light source.

Preferably, steps dd) to gg) may be repeated at preset times.

Another subject of the invention is a method for supplying electrical power to at least one semiconductor-element-comprising light source via a power-supplying system according to the invention, wherein the means for controlling electrical power supply comprise means for reading said properties of the first and second components and wherein, in the electronic circuit, a first branch comprising the first component and a second branch comprising the second component are mounted in parallel. At least one of the parallel branches comprises a selecting mechanism mounted in series with and upstream of the first/second component, which comprises a capacitor that only lets pass an electrical current of a preset frequency, the frequencies for the two branches being different. The method is noteworthy in that it comprises the following steps:

aaa) measuring the voltage drop across the terminals of said electronic circuit, when an electrical current of a preset magnitude and of a first frequency, passed by the selecting mechanism of the first branch, is flowing therethrough;

bbb) deducing the value of the property of the first component from the measured voltage drop;

ccc) recording the value of the property of the first component, which value is representative of the bin value of the light source, in a first memory element;

ddd) measuring the voltage drop across the terminals of said electronic circuit, when an electrical current of a preset magnitude and of a second frequency, passed by the selecting mechanism of the second branch, is flowing therethrough;

eee) deducing the value of the property of the second component from the measured voltage drop;

fff) recording the value of the property of the second component, which value is representative of the temperature of the environment of the light source at the time at which the measurement is taken, in a second memory element; and

ggg) delivering an electrical current to the light sources, the magnitude of the delivered electrical current depending on the bin value of the source and on the temperature of the environment of the light source.

Preferably, steps ddd) to ggg) may be repeated at preset times.

Using the measures proposed by the present invention, it becomes possible to decrease the number of cables between a device for controlling the supply of electrical power to light sources, and a printed circuit board bearing said light sources, with respect to techniques known in the art. In the prior art, a first cable is required to guarantee the supply of power to the light sources, and a second dedicated cable is necessary to collect the bin information of the light sources, which are for example light-emitting diodes (LEDs). Other multiple additional cables become necessary in prior-art solutions, if parameters such as LED junction temperature must be taken into account by the controlling device. Specifically, this information is necessary to suitably control the supply of power to LEDs. According to the invention, this third (or more) dedicated cable becomes superfluous and may be removed, since bin information, temperature information or any other information may be collected by the device for controlling electrical power supply via a single cable. The decrease in the number of cables is particularly large in the context of the design of motor-vehicle lights, in which a controlling device may be required to supply power to a plurality of lighting functions of the vehicle, this involving a corresponding number of pieces of bin information, of temperature information, and of information of other types, to be collected. The decrease in the number of cables decreases production cost and also decreases design constraints related to the electromagnetic compatibility of a lighting module. The number of connectors, at each end of the cables, is decreased with the decrease in the number of cables.

Other features and advantages of the present invention will be better understood from the description, which is given by way of example, and the drawings, in which:

FIG. 1 is a schematic representation of an electrical-power-supplying system according to one preferred embodiment of the invention;

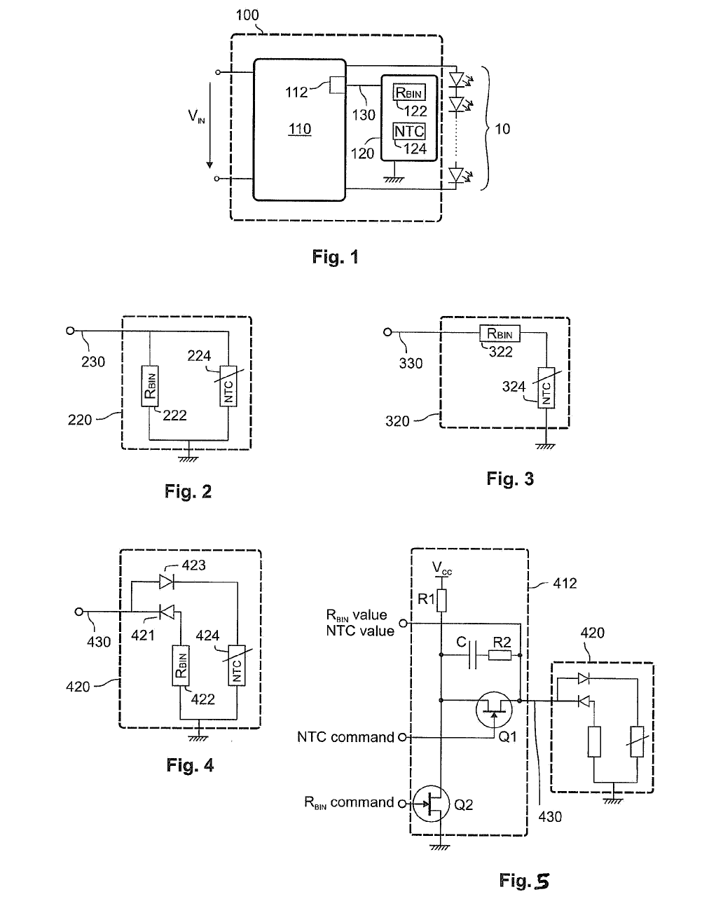

FIG. 2 is a schematic representation of an electronic circuit such as it is employed in an electrical-power-supplying system according to one preferred embodiment of the invention;

FIG. 3 is a schematic representation of an electronic circuit such as it is employed in an electrical-power-supplying system according to one preferred embodiment of the invention;

FIG. 4 is a schematic representation of an electronic circuit such as it is employed in an electrical-power-supplying system according to one preferred embodiment of the invention;

FIG. 5 is a schematic representation of reading means and of an electronic circuit such as they are employed in an electrical-power-supplying system according to one preferred embodiment of the invention;

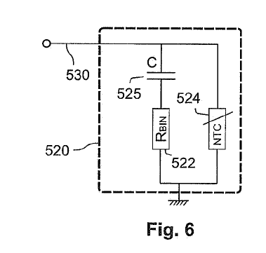

FIG. 6 is a schematic representation of an electronic circuit such as it is employed in an electrical-power-supplying system according to one preferred embodiment of the invention.

Unless otherwise indicated, technical features described in detail for a given embodiment may be combined with the technical features described in the context of other embodiments described by way of nonlimiting example Similar reference numbers will be used to describe similar concepts in various embodiments of the invention. For example, the references 120, 220, 320, 420 and 520 designate an electronic circuit according to the invention, in five described embodiments.

The illustration in FIG. 1 shows a system 100 for supplying electrical power to at least one semiconductor-element-comprising light source 10. The one or more light sources are preferably, but nonlimitingly, light-emitting diodes (LEDs). The LEDs 10 for example provide a lighting function of a motor vehicle, within a lighting module of the motor vehicle. It may be a question of a daytime running light, of a direction indicator, of a position lamp, etc. The power-supplying system 100 employs, in a known way, components that are not illustrated, in addition to the components that are relevant to the description of the present description. Thus, the controlling means 110 generally employ converter circuits, for example of the buck, boost, or SEPIC type, inter alia, suitable for converting an input DC voltage Vin, for example delivered by an internal battery of the motor vehicle, to a load voltage of different value and suitable for powering the LEDs electrically.

The power-supplying system according to the invention differs from known systems in that a single conductor 130 connects the reading means 112 to an electronic circuit 120 that is independent of the load branch that comprises the light sources 10. The electronic circuit 120 contains a first component 122 a measurable property of which is representative of said bin value of the source, and a second component 124 a measurable property of which is dependent on the temperature of the environment of the LEDs. Preferably, the first component 122 is a resistor Rbin the ohmic value of which is representative of the bin value of the source, and the second component 124 is a thermistor the ohmic value of which is dependent on the temperature of the component.

The bin value is required to correctly configure the controlling means 110 on initialization thereof, which is generally done during the assembly of a headlamp incorporating the system 100 and the light source 10. Given the bin value, the controlling means 110 are configured to deliver an electrical current of a magnitude suitable for the LEDs 10. During operation of the headlamp within a motor vehicle, the temperature of the LEDs varies due to meteorological conditions outside of the vehicle, but also due to heating of the electronic components, which is a consequence of their operation. As the temperature of the semiconductor junction of an LED changes its forward voltage, it is also necessary to deliver an indication of this temperature to the controlling means, in order to adapt the load current delivered to the LEDs 10. A thermistor placed in proximity to the LEDs, for example on the same printed circuit board, allows a representation of the temperature of the environment of the LEDs, which may be considered to be a representation of their junction temperature, to be obtained. The behavior of the ohmic resistance of the thermistor 124 as a function of its temperature is an inherent property of the thermistor. This property is known and pre-recorded in a memory element of the controlling means 110 or of the reading means 112. By using a single wire to collect these two pieces of information, the measurements according to the invention allow the design of the power-supplying system to be made easier, while decreasing the overall cost of the required components.

FIG. 2 shows one preferred embodiment of the electrical circuit 220, connected by the single conductor 230 to the means for controlling the supply of power to the LEDs, the two latter elements not being shown for the sake of clarity. The controlling means are arranged so as to be able to collect the bin datum, which is encoded by the resistor Rbin 22, and the temperature of the component 224, via the single connecting wire 230. In the electronic circuit 220, the two components 222 and 224 are mounted in parallel. During the assembly of the headlamp, the temperature of the thermistor is equal to an ambient temperature, preferably located between 10° C. and 40° C. The resistance of the thermistor is therefore known at this temperature. During the assembly, the resistance Rbin, which is unknown at this time, must however be read by the reading means. Thus, an electrical current of preset magnitude I is applied to the electronic circuit 220 by the controlling means. The observed voltage drop U allows the value of the equivalent resistance Req of the electronic circuit 220, Req=U/I, to be obtained. As Req=(Rbin·Rntc)/(Rbin+Rntc), and as Rntc is known since the temperature at the moment of the measurement is known, the reading means may therefore deduce therefrom the resistance Rbin. The resistance Rbin indicates the bin value of the LEDs and it is preferably stored in a memory element in order to be used in the configuration of the controlling means. During operation of the headlamp, although the resistance Rbin is already known, temperature is an unknown quantity. By carrying out the procedure just described above, the resistance Rntc, which gives an indication of the temperature of the environment of the LEDs, is deduced from the observed resistance Req, and from the resistance Rbin, which is already known. In order to perform the calculations just described above, the reading means employ either a dedicated electronic circuit, or a microcontroller element programmed to this end, and an analog/digital converter. The read-out of the temperature and the adaptation of the magnitude of the electrical current delivered to the LEDs, so that they emit a constant light flux independently of their junction temperature, are preferably repeated, for example periodically during the operation of the system according to the invention.

FIG. 3 shows another preferred embodiment of the electrical circuit 320, connected by the single conductor 330 to the means for controlling the supply of power to the LEDs, the two latter elements not being shown for the sake of clarity. The controlling means are arranged so as to collect the bin datum, which is encoded by the resistor Rbin 32, and the temperature of the component 324, via the single connecting wire 330. In the electronic circuit 320, the two components 322 and 324 are mounted in series. During the assembly of the headlamp, the temperature of the thermistor is equal to an ambient temperature, preferably located between 10° C. and 40° C. The resistance of the thermistor is therefore known at this temperature. During the assembly, the resistance Rbin, which is unknown at this time, must however be read by the reading means. Thus, an electrical current of preset magnitude I is applied to the electronic circuit 320 by the controlling means. The observed voltage drop U allows the value of the equivalent resistance Req of the electronic circuit 320, Req=U/I, to be obtained. As Req=Rbin+Rntc, and as Rntc is known since the temperature at the moment of the measurement is known, the reading means may therefore deduce therefrom the resistance Rbin. The resistance Rbin indicates the bin value of the LEDs and it is preferably stored in a memory element in order to be used in the configuration of the controlling means. During operation of the headlamp, although the resistance Rbin is already known, temperature is an unknown quantity. By carrying out the procedure just described above, the resistance Rntc, which gives an indication of the temperature of the environment of the LEDs, is deduced from the observed resistance Req, and from the resistance Rbin, which is already known.

FIGS. 4 to 6 show other preferred embodiments according to the invention in which, in the electronic circuit 420, 520, a first branch comprising the first component, for example the resistor Rbin, and a second branch comprising the second component, for example the thermistor NTC, are mounted in parallel. At least one of the two branches comprises a selecting mechanism that is mounted in series and upstream of the first and/or second component. The selecting mechanism is configured to let an electrical current flowing through the electronic circuit selectively pass through the branch in question, depending on a property of the electrical current. By configuring the controlling means so as to inject, at different reading times, electrical currents with different properties, it then becomes possible to selectively read either the bin information or the temperature information, via the single conductor 430, 530 that connects the electronic circuit 420, 520 to the controlling means.

In the embodiment illustrated in FIGS. 4 and 5, the electronic circuit 420 comprises two parallel branches containing the first component Rbin 422 and the second component 424, respectively. Upstream of each of these components, each branch comprises a diode 421, 423. Each of the diodes lets pass an electrical current of a single polarity, and the two diodes let pass electrical currents of inverse polarities. Thus, by injecting an electrical current having a first polarity that is passed by the diode 421, but that is not passed by the diode 423, the reading means are able to collect the resistance Rbin by observing the voltage drop induced by the component 422. Likewise, by injecting an electrical current having a second polarity that is the inverse of the first polarity and that is passed by the diode 423 but not by the diode 421, the reading means are able to collect the resistance Rntc by observing the voltage drop induced by the component 424. Thus, during assembly of the headlamp, the bin value is collected by selectively injecting an electrical current having the appropriate polarity, and during operation of the headlamp, the value of the temperature of the environment of the LEDs is collected by selectively injecting an electrical current having an inverse polarity. FIG. 5 shows by way of example reading means 412 configured to selectively inject an electrical current having either a positive or negative polarity into the electronic circuit 420. Obviously, a person skilled in the art will be able to implement various electronic circuits to achieve the same functionality, without however departing from the scope of the present invention.

In the embodiment illustrated in FIG. 6, the electronic circuit 520 comprises two branches mounted in parallel and containing the first component Rbin 522 and the second component 524, respectively. A capacitor 525 is mounted upstream of the component 522. The capacitor only lets pass an electrical current having a preset frequency, the latter depending on the capacitance of the capacitor. When a DC current is made to flow through the electronic circuit 520, the component 522 is therefore not supplied with electrical current. Thus, by injecting an electrical current having the required frequency—for example a clock signal—that is passed by the capacitor 525, the reading means are able to collect the resistance Rbin by observing the voltage drop induced by the component 522. At temperature, the resistance of Rbin may be considered equivalent to the equivalent resistance of the circuit 520, whereas Rntc (known at ambient temperature) is negligible with respect to Rbin. Likewise, by injecting a DC electrical current, which passes only through the component 524, the reading means are able to collect the resistance Rntc by observing the voltage drop induced by the component 424. Thus, during assembly of the headlamp, the bin value is collected by selectively injecting an electrical current having the appropriate frequency, and during operation of the headlamp, the value of the temperature of the environment of the LEDs is collected by selectively injecting a DC electrical current. Alternatively, capacitors with different capacitances may be placed in the two branches and electrical currents with different frequencies used to collect the bin and temperature information, respectively.

It goes without saying that other electronic circuits that implement the described functionalities may be envisioned, without however departing from the scope of the present invention. Likewise, the described principles may be applied to the encoding and collection of more than two light-source properties using the electronic circuit according to the invention.

1. System for supplying electrical power to at least one semiconductor-element-comprising light source of a motor vehicle, the system comprising:
means for controlling the supply of electrical power to said light source, said means being configured to deliver an electrical current to said light source, the magnitude of the delivered electrical current depending on a bin value of the source and on the temperature of the environment of the source; and
an electronic circuit, which is independent of said light source, comprising a first component a measurable property of which is representative of said bin value of the source, and a second component a measurable property of which is dependent on the temperature of the environment of the light source,
wherein the controlling means are arranged to determine said properties of the first and second components via a single electrically conductive wire connecting the controlling means to the electronic circuit.

2. System according to claim 1, wherein the controlling means comprise means for reading said properties of the first component and second component, said reading means being configured:
at a first preset temperature, wherein the property of the second component is known, to measure the voltage drop across the terminals of said electronic circuit, when an electrical current of a preset magnitude is flowing therethrough;
to deduce the value of the property of the first component from the measured voltage drop and from the property of the second component; and
to record the value of the property of the first component, which value is representative of the bin value of the light source, in a first memory element.

3. System according to claim 2, wherein the reading means are furthermore configured:
to measure the voltage drop across the terminals of said electronic circuit, when an electrical current of a preset magnitude is flowing therethrough;
to deduce the value of the property of the second component from the measured voltage drop and from the value of the property of the first component, i.e. the value stored beforehand in the first memory element; and
to record the value of the property of the second component, which value is representative of the temperature of the environment of the light source at the time at which the measurement is taken, in a second memory element.

4. System according to claim 1, wherein the first component and the second component are mounted in parallel in the electronic circuit.

5. System according to claim 1, wherein the first component and the second component are mounted in series in the electronic circuit.

6. System according to claim 1, wherein:
a first branch comprising the first component and a second branch comprising the second component are mounted in parallel in the electronic circuit, at least one of the branches comprising a selecting mechanism mounted in series and upstream of said first/second component, the selecting mechanism being configured to let an electrical current flowing through the electronic circuit selectively pass through said branch, depending on a property of the electrical current, and wherein the controlling means comprise means for reading said properties of the first and second components, said reading means being configured to selectively inject an electrical current having a preset property into the electronic circuit.

7. System according to claim 6, wherein each of the parallel branches comprises a selecting mechanism comprising a first diode and a second diode only letting an electrical current of a given polarity pass, respectively, the diodes of the two branches letting electrical currents of inverse polarities pass, and wherein the means for reading said properties of the first component and second component are configured:
to measure the voltage drop across the terminals of said electronic circuit, when an electrical current of a preset magnitude and of a first polarity, passed by the first diode, is flowing therethrough;
to deduce the value of the property of the first component from the measured voltage drop; and
to record the value of the property of the first component, which wherein value is representative of the bin value of the light source, in a first memory element.

8. System according to claim 7, wherein the reading means are furthermore configured:
to measure the voltage drop across the terminals of said electronic circuit, when an electrical current of a preset magnitude and of a second polarity, which is the inverse of the first polarity and which is passed by the second diode, is flowing therethrough;
to deduce the value of the property of the second component from the measured voltage drop; and
to record the value of the property of the second component, wherein the value is representative of the temperature of the environment of the light source at the time at which the measurement is taken, in a second memory element.

9. System according to claim 6, wherein at least one of the parallel branches comprises a selecting mechanism that comprises a capacitor that only lets pass an electrical current of a preset frequency, the frequencies for the two branches being different, and in that wherein the means for reading said properties of the first component and second component are configured:
to measure the voltage drop across the terminals of said electronic circuit, when an electrical current of a preset magnitude and of a first frequency, passed by the selecting mechanism of the first branch, is flowing therethrough;
to deduce the value of the property of the first component from the measured voltage drop; and
to record the value of the property of the first component, wherein the value is representative of the bin value of the light source, in a first memory element.

10. System according to claim 9, wherein the reading means are furthermore configured:
to measure the voltage drop across the terminals of said electronic circuit, when an electrical current of a preset magnitude and of a second frequency, passed by the selecting mechanism of the second branch, is flowing therethrough;
to deduce the value of the property of the second component from the measured voltage drop; and
to record the value of the property of the second component, which wherein the value is representative of the temperature of the environment of the light source at the time at which the measurement is taken, in a second memory element.

11. System according to claim 9, wherein only the first branch of the parallel branches, i.e. the branch comprising the first component having a property representative of the bin value of the light source, comprises said selecting mechanism.

12. System according to claim 1, wherein the first component is a resistor the ohmic value of which is representative of the bin value of the light source.

13. System according to claim 1, wherein the second component is a thermistor the ohmic value of which depends on the temperature of the component.

14. Motor-vehicle lighting module comprising at least one semiconductor-element-comprising light source and a system for supplying electrical power to said light source, wherein the electrical-power-supplying system is according to claim 1.

15. Method for supplying electrical power to at least one semiconductor-element-comprising light source via a power-supplying system according to claim 1, wherein the means for controlling the supply of electrical power comprise means for reading said properties of the first component and second component, and wherein the method comprises the following steps:
a) at a first preset temperature, wherein the property of the second component is known, measuring the voltage drop across the terminals of said electronic circuit, when an electrical current of a preset magnitude is flowing therethrough;
b) deducing the value of the property of the first component from the measured voltage drop and from the property of the second component;
c) recording the value of the property of the first component, wherein the value is representative of the bin value of the light source, in a first memory element;
d) measuring the voltage drop across the terminals of said electronic circuit, when an electrical current of a preset magnitude is flowing therethrough;
e) deducing the value of the property of the second component from the measured voltage drop and from the property of the first component, which is the property recorded beforehand in the first memory element;
recording the value of the property of the second component, wherein the value is representative of the temperature of the environment of the light source at the time at which the measurement is taken, in a second memory element; and
g) delivering an electrical current to the light sources, the magnitude of the delivered electrical current depending on the bin value of the source and on the temperature of the environment of the light source.

16. System according claim 2, wherein the first component and the second component are mounted in parallel in the electronic circuit.

17. System according to claim 2, wherein the first component and the second component are mounted in series in the electronic circuit.

18. System according to claim 10, wherein only the first branch of the parallel branches, i.e. the branch comprising the first component having a property representative of the bin value of the light source, comprises said selecting mechanism.

19. System according to claim 2 wherein the first is a resistor the ohmic value of which is representative of the bin value of the light source.

20. System according to claim 2, wherein the second component is a thermistor the ohmic value of which depends on the temperature of the component.
